(19) United States
(12) Patent Application Publication
(10) Pub. No.: US 2004/0156293 A1
(43) Pub. Date: Aug. 12, 2004

(54) Apparatus for reprocucing a digital information signal

(76) Inventors: Charalampos Pozidis, Gattikon (CH); Willem Marie Julia Marcel Coene, Eindhoven (NL); Johannes Wilhelmus Maria Bergmans, Eindhoven (NL)

Correspondence Address: Philips Electronics North America Corporation, Corporate Patent Counsel, PO Box 3001, Briarcliff Manor, NY, 10510, US

(21) Appl. No.: 10/480,112

(22) PCT Filed: Jun. 18, 2002
(86) PCT No.: PCT/IB02/02326

(30) Foreign Application Priority Data
Jun. 19, 2001 (EP) 01202341.2

(51) Int. Cl. G11B 7/005

(52) U.S. Cl. 369/59.22

(57) ABSTRACT

Domain bloom, also known as asymmetry, is a systematic imperfection caused by the writing process in optical discs. During disc read-out it causes signal transitions to shift with respect to their nominal positions. State-of-the-art equalization and detection methods suffer significant performance losses if directly applied to replay signals with asymmetry. A non-linear model for replay signals with asymmetry is used for new equalization and detection techniques that are applicable to signals in the presence of asymmetry. Modifications are described of the threshold bit-detector, the run-length pushback bit-detector, and the PRML sequence detector, which have significant performance benefits. These benefits come at almost no additional cost with respect to existing detectors.

The invention relates to an apparatus able to read information on a record carrier, which information is present on the record carrier in the form of marks, the apparatus comprising:

reading means able to read a data signal from the record carrier;

preprocessing means able to convert the read data signal into a processed signal suitable for further processing;

bit detection means able to derive an information signal from the processed signal;

channel decoding means able to decode the information signal, and

asymmetry parameter estimator means able to derive an asymmetry parameter estimate indicative of an asymmetry in the read signal.

Some of the principal non-linearities in optical recording arise at the writing end of the system, and are caused by differences in the effective size of the marks, in the form of pits and lands, of the same nominal size. This phenomenon manifests itself in the reading end in the form of asymmetries in the eye pattern of the replay signal. The asymmetry in the eye pattern of the replay signal as a result of the differences in the length of the pits and lands is also referred to as domain bloom asymmetry. Asymmetry may be caused, for example, by a systematic deviation of the recording laser power from a nominal value. A positive deviation causes pits to be effectively longer than lands of the same nominal size (over-etching), while negative deviation has the opposite effect (under-etching). Asymmetry is more profound in mastered systems for read-only applications (ROM) than in phase-change (re-writable) ones; this is due to the finer control of the writing process in re-writable systems, where, in the write strategy, which consists of a series of short laser pulses at different powers (typically n−1 pulses for a mark runlength of n channel bits), an erase pulse at the end of the pit permits realization of short marks with the same (radial) width as for large marks. This obviates the need to increase the length of the shortest marks in order to increase their modulation. Shifting to optical recording systems of high capacities necessitates mastering of very small pits. Conventional state-of-the-art laser beam recorders use lasers with wavelengths in the deep ultra-violet (DUV) range, with a resolution that is barely adequate to master pits of the size necessary in order to achieve disc capacities of 25 GB. This effectively leads to very narrow process windows, which means that very accurate control of the laser power is needed to guarantee optimal pit sizes. Even small variations around the optimal power values can lead to large asymmetries during mastering [1]. The main effects of asymmetry in the replay signal are a shift of the central eye with respect to the (nominal) slicing level, and a reduction of the central eye opening. Although detection can be improved by shifting the slicing level accordingly (which can be partially accurately achieved through the use of slicer adaptation, which makes use of the DC-free property of the RLL code as is proposed in [8], which forms part of the prior art with respect to asymmetry handling), the reduction of the eye opening will cause a deterioration of the bit-error-rate (BER) performance, with respect to the case of zero asymmetry. This necessitates some form of equalization and/or more powerful forms of detection, especially when asymmetry is high.

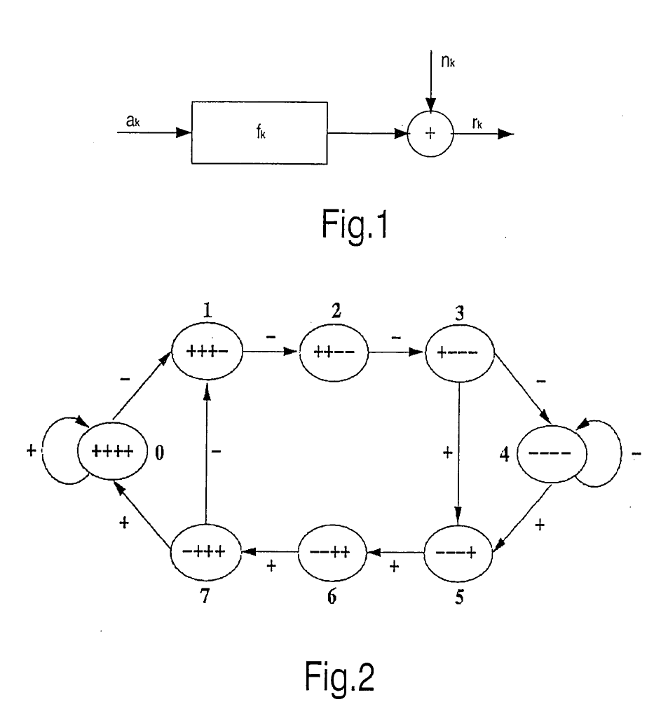

When no asymmetry is present in the recording process, the replay signal can be modeled by a linear system with a reasonable degree of accuracy. It should be noted, however, that the physical detection process at the photo-detector is inherently a non-linear process; although the complex-valued optical wavefront is linear in the stored bits, its power distribution, which is non-linear, is actually recorded, but these non-linearities turn out to be rather small at current disc densities. A simple discrete-time model of the replay signal is illustrated in FIG. 1. We can arrive at this model by applying an analog low-pass filter to the continuous-time replay signal, followed by a baud-rate sampler.

In FIG. 1 aₖ stands for the coded information bits stored on the disc, shortly called channel bits, fₖ is a model for the optical recording channel, and nₖ is an additive noise process. Note that aₖ assumes values from {−1, 1}. In the sequel we will assume that noise is additive, white and Gaussian. In optical recording, the information bits are coded before they are stored on the disc. This form of coding is known as modulation coding, and its two main purposes are to minimize the distortion that the signal undergoes in the process of storage to and retrieval from the disc, and to enable timing recovery. Modulation codes for storage applications are usually run-length-limited (RLL) codes. RLL codes are characterized by two numbers, d and k, which are called run-length constraints. The d and k-constraints designate that successive bit-transitions (indicated by the “1”-bits in the NRZ channel bitstream) in the coded bit-stream are spaced at least d and at most k bit positions apart, respectively. In other words, between two successive “1”-bits there must me at least d and at maximum k zeroes. Equivalently stated, these constraints limit the run-lengths (successions of equal bits) in the bipolar NRZI channel bitstream of the coded sequence to a number between d+1 and k+1. As a result, not all possible sequences of bits are valid RLL bit-streams. For example, out of the eight possible three-bit sequences, the triplets −+− and +−+ are not allowed in a d=1 code. Here, and in the rest of this document, ‘+’ stands for +1, and ‘−’ for −1.

The read-out of optical discs is a dynamic process during which several physical parameters vary, such as tangential tilt, radial tilt and defocus: these variations are on a relatively large time-scale compared with the user data rate of information on the disc. This results in a time variation of the optical channel impulse response which can degrade the overall performance of the receiver if not treated adequately. One way to cope with such dynamic variations is through adaptive equalization: the replay signal samples rₖ are fed to an equalizer, which is typically an FIR filter with adjustable coefficients. In one possible setting, the equalizer coefficients are adjusted such that the overall filter, the cascade of channel and equalizer, resembles as well as possible a fixed, pre-defined target response. This response is called partial response, and the corresponding method partial response equalization (see [3] for a concise treatment of that matter). A partial response often comprises a small number of taps, and captures most of the amplitude distortion of the channel fₖ. The latter is to assure that equalization will not result in severe noise enhancement.

In the following we assume that an (adaptive) linear equalizer with taps wₖ filters the noisy channel output rₖ, in order to transform the overall response to a partial response denoted gₖ. The sequence at the output of the equalizer is given by:

yₖ=(r*w)ₖ=(a*f*w)ₖ+(n*w)ₖ=(a*p)ₖ+uₖ (1)

where pₖ=(f*w)ₖ is the combined (channel and equalizer) response, which, if equalization is perfect, should equal gₖ, and uₖ is filtered noise. The coefficients of the adaptive linear equalizer filter are adjusted by a control loop, which is driven by an appropriate error signal. For partial response equalization, the error signal is formed as the difference between the equalizer output (the actual input to the detector that follows the equalizer) and a ‘desired’ equalizer output, i.e.,

eₖ=yₖ−(â*g)ₖ (2)

Here (â*g)ₖ stands for the desired sequence at the output of the equalizer, and âₖ are estimates of the actual channel bits produced by the detector. Minimization of a correlated version of eₖ drives the equalizer taps to their desired settings.

The partial response is assumed to have a memory length of L symbol intervals, so that

$${g}_{k} = 0 , for k ∉ \{ - \frac{L}{2} , … , \frac{L}{2} \} \qquad ( 3 )$$

As mentioned before, gₖ is chosen such that it captures most of the amplitude distortion of the channel fₖ. Under nominal conditions, the optical channel impulse response resembles a (sinc² (t)) pulse, and gₖ is usually chosen to have a similar shape. The partial response is then symmetric around its middle point, and induces a delay of L=2 symbol intervals. In the following we assume that L is an even number.

Let us consider an example with L=4, which is typical for optical recording channels of practical interest. Since gₖ is symmetric around its middle point and induces a delay of two symbol intervals, we can explicitly reflect these properties by writing:

gₖ=g₀δₖ+g₁(δₖ₋₁+δₖ₊₁)+g₂(δₖ₋₂+δₖ₊₂) (4)

where δₖ denotes the unit impulse. From (1) (with pₖ=gₖ) and (4) we can express the sequence at the equalizer output as:

yₖ=g₀aₖ+g₁(aₖ₋₁+aₖ₊₁)+g₂(aₖ₋₂+aₖ₊₂)+uₖ (5)

The data component of yk is fully determined by a sequence of 5 consecutive bits aₖ₋₂, . . . ,aₖ₊₂. For a d=2 constraint, some of the 5-bit sequences are not allowed. The remaining combinations, along with the corresponding data levels (a*g)ₖ, are illustrated in Table 1. The number of d-constrained bipolar sequences of length n is given by 2N_{d}(n−1), with N_{d} the number of d-constrained sequences in the NRZ format (with ‘1’s indicating transitions). Since N_{d}=2(4)=6, only 12 out of the 32 possible 5-bit sequences are allowed. Moreover, due to the symmetry of gₖ, (a*g)ₖ assumes only 8 distinct values. These observations are used in the design of a maximum likelihood sequence detector for yₖ in the next section.

TABLE 1
Admissible d = 2 bit-patterns and corresponding noiseless
channel output for a 5-tap symmetric channel.

| Bit-pattern | Sample value | Bit-pattern | Sample value |
|---|---|---|---|
| −−+++ | g₀ | ++−−− | −g₀ |
| +++−− | g₀ | −−−++ | −g₀ |
| −+++− | g₀ + 2g₁ − 2g₂ | +−−−+ | −g₀ − 2g₁ + 2g₂ |
| −++++ | g₀ + 2g₁ | +−−−− | −g₀ − 2g₁ |
| ++++− | g₀ + 2g₁ | −−−−+ | −g₀ − 2g₁ |
| +++++ | g₀ + 2g₁ + 2g₂ | −−−−− | −g₀ − 2g₁ − 2g₂ |

Current optical recording products such as CD and DVD are designed in such a way as to be robust under various operating conditions. In these systems, even simple bit-by-bit detection schemes can provide adequate performance margins. However, the necessity for high overspeed factors and the proliferation of recordable discs of sometimes low quality necessitate more powerful signal processing in the receiver. From a detection point of view, this means shifting to sequence detection schemes, which can guarantee near-optimal performance at the expense of higher complexity. Both types of detection methods are described in the sequel (prior art).

The simplest bit-by-bit detector is the binary slicer, also known as threshold detector (TD). The TD produces bit estimates by quantizing the sample values of the replay signal; if the sample value exceeds a threshold level a +1 bit is produced, while a −1 corresponds to values below the threshold. In actual receivers the slicer (threshold) level is adaptively adjusted based on the sample values of the replay signal. This procedure makes use of the DC-free property of a run length limited code, which forces an equal number of +1's and −1's in the channel bit stream. Slicer level control accordingly aims at maintaining this condition at the bit stream in the TD output.

Ideally, the optimal slicer level is positioned in the middle of the inner eye in the eye pattern of the sequence at the detector input. The inner eye is in turn determined by the smallest pit amplitude and the smallest land amplitude. These are the amplitudes at the edges of the shortest domain, which, for a d=2 channel code, comprises 3 channel bits and is denoted 3T. In the absence of asymmetry, the noiseless detector input values are listed in table 1. The smallest pit and land amplitudes are equal to −g₀ and g₀, respectively. Consequently, the optimal slicer level for TD is equal to zero in that case. The bit-error-rate performance of the TD can be improved by means of simple post-processing, which exploits the d-constraint of the run length limited code. The combination of TD and post-processing is known as the run-length pushback detector (RPD) or run-detector [4, 5]. Post-processing amounts to detecting runs which violate the d-constraint in the TD output, and transforming them into runs of the minimal allowable length 3T runs in the d=2 case). The first stage of the RPD is a TD, therefore a slicer level is necessary for its operation.

The optimal slicer level for the RPD need not be equal to that of the standalone TD. The optimal RPD threshold is equal to the average of two amplitude levels: the amplitude of the detector input sequence sample corresponding to the edge bit of a pit, and the one corresponding to the edge bit of a land. For a signal without asymmetry, and for a 5-tap gₖ, these levels are equal to −g₀ and g₀, respectively, as shown in table 1. The resulting optimal slicer level is then equal to zero. It can actually be shown that, even for longer responses gₖ, in the absence of asymmetry, the optimal thresholds for TD and RPD are both equal to zero. However, as we shall see, this is not the case when asymmetry is present.

The maximum likelihood sequence detector (MLSD) attempts to find the data sequence âₖ, out of all possible d-constraint compliant bit-sequences, whose filtered version (â*g)ₖ matches the equalizer output sequence yₖ as well as possible. Since gₖ is a partial response (with fewer taps than the actual channel impulse response), this detector is often called a partial response maximum likelihood (PRML) detector. Given the sequence yₖ and the response gₖ, the PRML produces an estimate â_{k-D} of the actual channel sequence aₖ, where D>>L is the inherent detection delay. PRML detection is implemented by the Viterbi detector (VD), which is essentially a dynamic programming algorithm. The VD is characterized by a set of states, a directed graph connecting them (a state transition diagram, STD, or finite-state machine, FSM), and an underlying response (gₖ in this case). We focus on the partial response model of (4) with L=4 in what follows, although the results are applicable in general. Each state is a sequence of the L=4 most recent bits that reside in the channel memory, i.e.,

sₖⁱ≡{aₖ₋₂ᵢ, . . . ,aₖ₋₁ᵢ}, iε{0, . . . ,Nₛ} (6)

where Nₛ is the total number of states. We consider an STD of the Mealy-type, in which the labels at the edges of the directed graph represent the 5-tap sequences of channel bits shown in the Table 1. Although 2^{L} combinations of L bits are possible, many of them are excluded since they violate the code constraint d. This results in Nₛ being smaller than 2L. The d-constraint also precludes certain successions of states. For the purpose of illustration, we concentrate on d=2 sequences in the sequel, without loss of generality. Out of the 2⁴=16 possible states, only 8 (2N_{d=2}(n−1=3)) conform to the d=2 constraint, so Nₛ=8. The underlying state diagram (STD) of the VD in that case is shown in FIG. 2. There are 12 edges in total, and half of the 8 states have more than one incoming edge.

Each edge (branch) in the STD uniquely defines a succession of states, xₖ^{ij}=(sₖⁱ,sₖ₊₁^{j}), that is a succession of L+1=5 bits aₖ₋₂, . . . ,aₖ₊₂. As such, it also determines a noiseless detector input

zₖ=g₀αₖ+g₁(aₖ₋₁+aₖ₊₁)+g₂(aₖ₋₂+aₖ₊₂) (7)

and a corresponding branch metric

βₖ=H(yₖ−zₖ) (8)

where H(x) is a predefined even function of x (usually H(x)=x² or H(x)=|x|).

For each of the Nₛ states at each bit interval k, the VD keeps track of an associated path metric, which is an accumulation of branch metrics: the path leading to the lowest path metric (or path “costs”) is selected by a so-called add-compare-select (ACS) operation, yielding the ‘shortest’ path leading to that state. Path metrics are updated at each bit interval. For states with one incoming branch (like states 2,3,6 and 7) this only involves addition of the current branch metric to the maintained path metric. For the rest of the states, a selection between the two merging paths must be made. This is done by adding the respective current branch metrics to the two existing path metrics, comparing them, and selecting the path with the smallest updated path metric. These ACS operations determine the operational speed of the VD.

At each bit interval, the VD also identifies the state with the smallest current path metric. It then backtracks D steps through that path, and selects the associated bit â_{k-D} as its estimate of the actual channel bit a_{k-D.}

In [18] an adaptive maximum likelihood sequence estimation receiver is described that models the nonlinearities in a read signal by means of zero-memory non-linearity (ZNL) at the end of the complete channel, and further produces estimates of a set of parameters describing this ZNL non-linearity, and incorporates these estimates in the metric calculation of the receiver. The estimates of the nonlinearities are determined by a combination of different effects such as the read-out conditions of the read-channel with for example tangential tilt, radial tilt, mixed with conditions of the write-channel like domain bloom asymmetry. It should be noted that the asymmetry model used in [18] introduces the non-linearity at the very end of a linear read-out-channel, that is, the output of the linear channel is subject to a (memory-less) non-linear distortion. It is obvious that such an ad-hoc model as described in [18] cannot describe accurately enough the non-linearities in the system that originate at the very beginning of the complete channel, that is, at the side of the writing operation to the disc (write channel). The “complete” channel is seen as the concatenation of write-channel and read-channel.

The known apparatus for reproducing a digital information signal from a record carrier has a relatively high bit error rate when the size of the marks deviate from the nominal size.

It is an object of the invention to provide an apparatus for reproducing a digital information signal of the kind described in the opening paragraph, the apparatus having a relatively low bit error rate when the size of the marks deviates from the nominal size.

The object is realized in that the asymmetry parameter estimate is substantially determined by deviations of the size of the marks with respect to a nominal size and the apparatus is able to improve a bit error rate of the information signal when the size of the marks deviate from the nominal size by using the asymmetry parameter estimate.

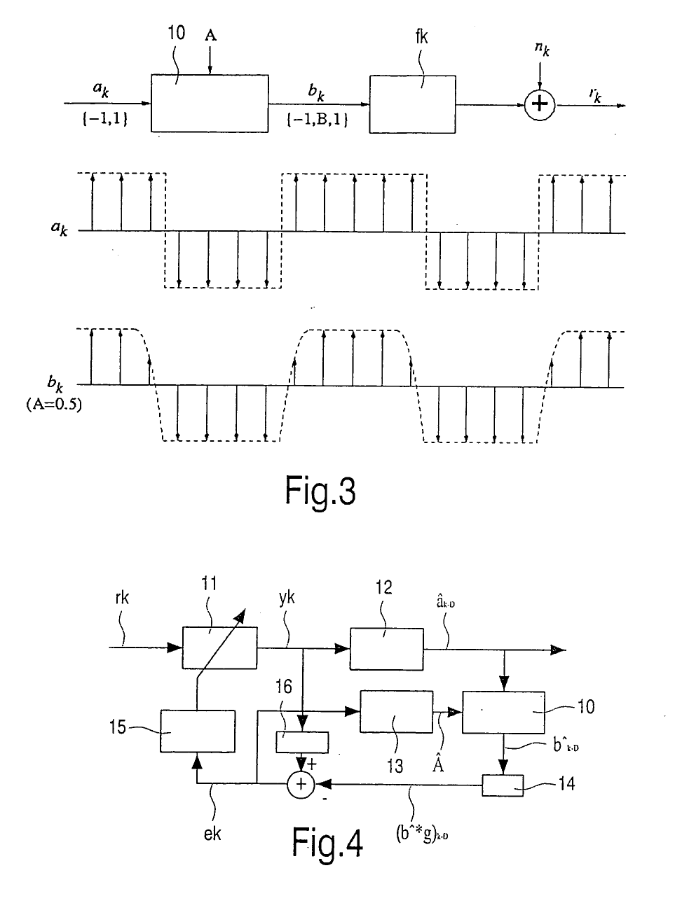

In optical recording systems, non-linearities in the writing process cause asymmetries in the eye pattern of the replay signal. A simple yet accurate model of signal asymmetry has been proposed in [2], and is illustrated in FIG. 3.

In FIG. 3, the channel bits aₖ are first subjected to a non-linear operation, characterized by a single parameter A, which transforms them into symbols bₖ. This is performed by the memory-to-non-linearity means 10. The symbols bₖ are then applied to the optical channel fₖ, and noise is added, to get the replay sequence

rₖ=(b*f)ₖ+nₖ (9)

where rₖ denotes the replay signal, as in (1) for zero asymmetry. The non-linear operation in FIG. 3 characterized by the single parameter A, accounts for the write non-linearities by reducing the amplitude of samples aₖ of one polarity that are immediately adjacent to a transition. The non-linearly transformed symbols bₖ are related to bits aₖ through the following equation [2]:

$${b}_{k} = {a}_{k} - \frac{1}{4} ( \vert A \vert + {Aa}_{k} ) ( 2 {a}_{k} - {a}_{k + 1} - {a}_{k - 1} ) \qquad ( 10 )$$

where A is a parameter that is linearly proportional to the asymmetry in the replay signal (for a definition of asymmetry see [6]). The single asymmetry parameter A is substantially determined by deviations of the size of the marks with respect to their nominal size. These deviations can comprise a longer width of the marks in the tangential direction, along the direction of the track, and/or a larger extent of the marks in the radial direction, orthogonal to the direction of the track. Samples bk assume values from a ternary alphabet {−1,B,1}, where B=1−A if A>0 and B=−1−A if A<0, or in general B=(1−|A|).sgn(A). The model of Equation 5 covers also the case of no asymmetry (bₖ=aₖ), by setting A=0.

The model of (10) can be used to improve a bit error rate of an apparatus for reproducing a digital information signal. An apparatus for reproducing a digital information signal which comprises an asymmetry parameter estimator means for deriving the asymmetry parameter of (10), has an improved bit error rate in the presence of domain bloom asymmetry. The asymmetry parameter A as used in (10) has the advantage that it is uniquely indicative of the size of the recorded pits, i.e. the asymmetry parameter estimate is substantially determined by deviation of the size of the marks: hence, this A-parameter model is a direct characterization of the write-channel. The known apparatus uses a set of parameter estimates for non-linearity that have no direct dependence on the characteristics of the write-channel, and are dependent on a mixture of conditions of the complete channel. Therefore the estimates used in the known apparatus are not substantially determined by the size of the recorded marks.

The size of the mark is determined by its length and width. Both the length and the width variation of the marks have an influence on the asymmetry parameter estimate A as used in (10).

These and other aspects of the invention will be apparent from and elucidated further with reference to the embodiments described by way of example in the following description and with reference to the accompanying drawings, in which

FIG. 4 shows an embodiment of the invention with a generic adaptive receiver topology for replay signals with asymmetry,

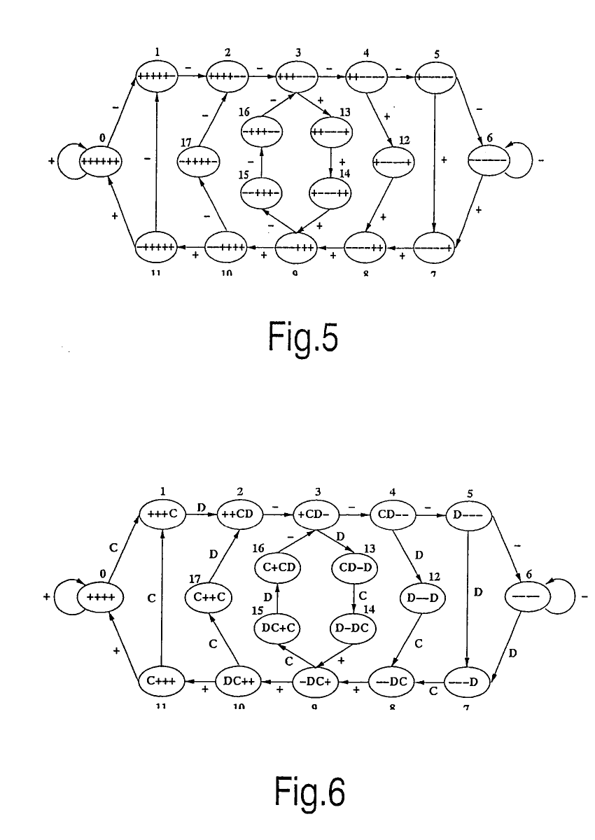

FIG. 5 shows a STD of five-taps full-fledged VD for d=2 signals in the presence of asymmetry,

FIG. 6 shows an alternative STD of five-taps full-fledged VD for d=2 signals in the presence of asymmetry,

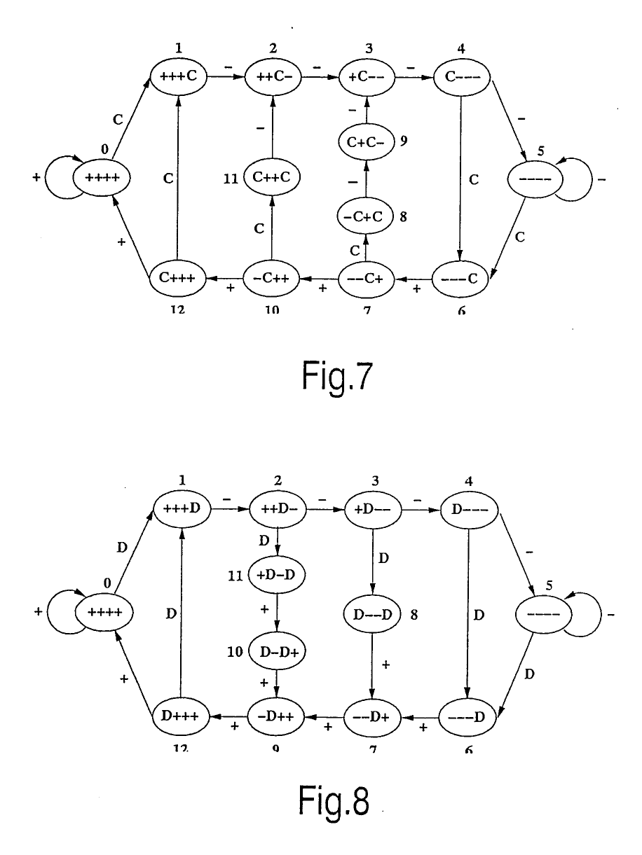

FIG. 7 shows a STD of five-taps full-fledged VD for d=2 signals in the presence of positive asymmetry,

FIG. 8 shows a STD of five-taps full-fledged VD for d=2 signals in the presence of negative asymmetry,

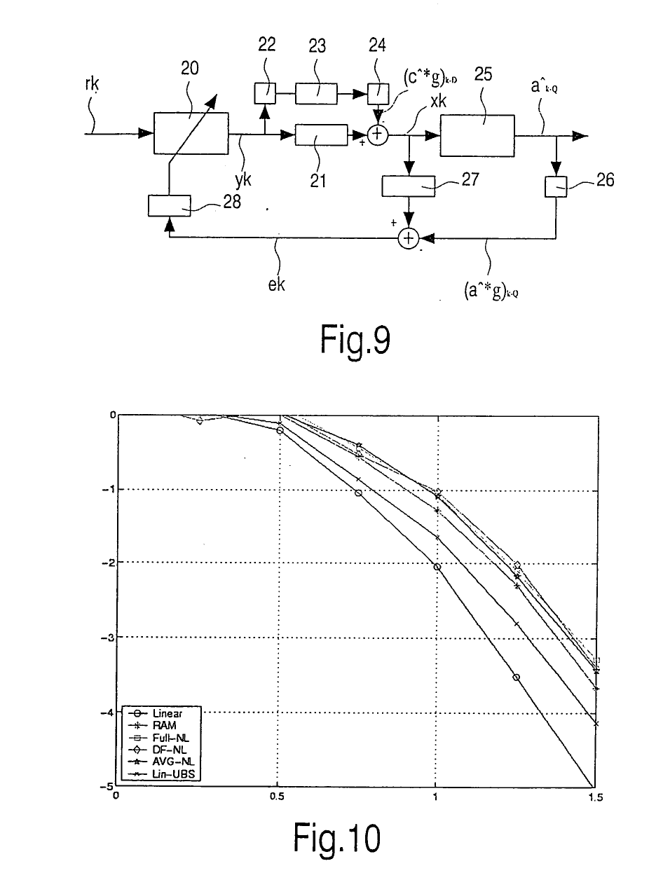

FIG. 9 shows an embodiment of the invention with a generic receiver topology for asymmetry cancellation,

FIG. 10 shows a graph of the SNR loss with respect to the matched filter bound for Viterbi Detectors on signals with asymmetry,

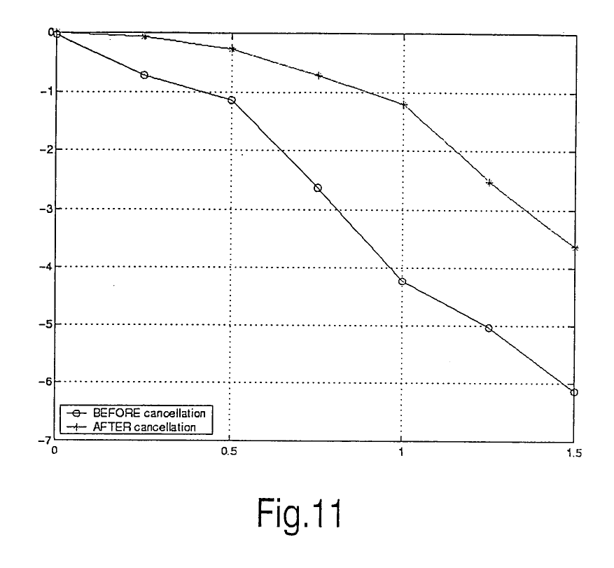

FIG. 11 shows a graph of the SNR loss of the binary slicer with and without asymmetry cancellation.

An embodiment of the apparatus is characterized in that the apparatus further comprises means able to derive an error signal by subtracting from the processed signal an estimate of the processed signal, the estimate being derived from an output signal of the bit detector by using the asymmetry parameter, and the preprocessing unit comprises a waveform equalizer being a FIR filter with adjustable coefficients which are able to be adjusted using a least mean square algorithm in order to minimize a mean square value of the error signal.

We can equalize the channel fₖ to a partial response gₖ by applying a linear filter wₖ to the replay sequence rₖ, i.e.,

yₖ=(r*w)ₖ=(b*f*w)ₖ+(n*w)ₖ=(b*p)k+uₖ (1)

As described previously, the use of adaptive equalization in optical recording provides the possibility to track dynamic variations of the optical channel during readout. In order to drive a control loop for adjusting the coefficients of the adaptive equalizer we need to define an appropriate error signal. As in the case of zero asymmetry, the error signal is formed as the difference between the equalizer output and a ‘desired’ version of it. In the presence of asymmetry the output of a linear equalizer with taps wₖ is given by equation 6, and is non-linear in the channel bits aₖ, through its dependence on the symbols bₖ. This non-linear dependence on aₖ should also be present on the ‘desired’ equalizer output, in order to assure convergence of the combined response pₖ=(f*w)ₖ to the partial response gₖ. We therefore define the error sequence for (partial response) equalizer adaptation in the presence of asymmetry as:

eₖ=yₖ−\check{y}ₖ=yₖ(\hat{b}*g)ₖ (12)

where \hat{b}ₖ are estimates of the actual symbols bₖ, obtained through equation 5 after replacing aₖ by bit-estimates aₖ and parameter Â by its estimate A. A method to estimate the parameter A is described further on. A generic topology of a receiver for replay signals with asymmetry, incorporating adaptive equalization as described here, is illustrated in FIG. 4.

In FIG. 4 the replay signal rₖ is led through an equalizer 11 resulting in a signal yₖ. From yₖ a detector 12 makes estimates â_{k-D} of the information stored on the record carrier. These estimates â_{k-D} are then used to obtain the non-linearly transformed symbols \hat{b}_{k-D} by the memory-to-non-linearity means 10. Through convolution means 14 the desired output of the equalizer 11 is obtained as (\hat{b}*g)_{k-D}. This term is subtracted from y_{k-D}, where y_{k-D} is obtained from yₖ by the delay means 16. The resulting error signal eₖ is used by the parameter update means 13 and the update algorithm means 15. The parameter update means 13 produces an update of the asymmetry parameter estimator Â. The update algorithm means 15 updates the taps Wk of the equalizer.

Assuming that pₖ=gₖ and that gₖ is given by (4), the equalizer output can be written as:

yₖ=g₀bₖ+g₁(bₖ₋₁+bₖ₊₁)+g₂(bₖ₋₂+bₖ₊₂)+uₖ (13)

The data component of yₖ is fully determined by a sequence of 5 consecutive symbols bₖ₋₂, . . . , bₖ₊₂. Each symbol bₖ is in turn defined by 3 consecutive bits aₖ₋₁, . . . ,aₖ₊₁ through (10). We can then equivalently re-express yₖ as:

yₖ=h(aₖ₋₃, . . . ,aₖ₊₂,aₖ₊₃)+uₖ (14)

where h(.) is a deterministic non-linear function of the recorded bits aₖ₋₃, . . . , aₖ₊₂, aₖ₊₃, and is defined by (13) in combination with (10). There are 2⁷=128 possible 7-bit sequences aₖ₋₃, . . . , aₖ₊₃ For a d=2 constraint the number of 7-bit sequences that are not allowed is 2N_{d=2}(n−1)=2N_{d=2}(6)=102. So there are only 26 out of the 2⁷=128 possible 7-bit sequences aₖ₋₃, . . . , aₖ₊₃ allowed. These sequences, along with the corresponding 5-bit sequences bₖ₋₂, . . . , bₖ₊₂, and the associated data levels h(aₖ₋₃, . . . , aₖ₊₂, aₖ₊₃)=(b*g)ₖ are shown in Table 2.

The variables C and D in Table 2 relate to parameter A of the non-linear model according to:

$$C = \{ \begin{matrix}1 - A & if A \geq 0 \\ 1 & if A < 0\end{matrix} , D = \{ \begin{matrix}- 1 & if A \geq 0 \\ - 1 - A & if A < 0\end{matrix} \qquad ( 15 )$$

TABLE 2
Admissible d = 2 7-bit sequences aₖ, corresponding
5-bit sequences bₖ, and corresponding noiseless
channel output, for a 5-tap symmetric channel.

| aₖ-pattern | bₖ-pattern | Sample value (A > 0) | Sample value (A < 0) |
|---|---|---|---|
| +++++++ | +++++ | g₀ + 2g₁ + 2g₂ | g₀ + 2g₁ + 2g₂ |
| ++++++− | ++++C | g₀ + 2g₁ + (2 − A)g₂ | g₀ + 2g₁ + 2g₂ |
| −++++++ | C++++ | g₀ + 2g₁ + (2 − A)g₂ | g₀ + 2g₁ + 2g₂ |
| −+++++− | C+++C | g₀ + 2g₁ + 2(1 − A)g₂ | g₀ + 2g₁ + 2g₂ |
| +++++−− | +++CD | g₀ + (2 − A)g₁ | g₀ + 2g₁ − Ag₂ |
| −++++−− | C++CD | g₀ + (2 − A)g₁ − Ag₂ | g₀ + 2g₁ − Ag₂ |
| −−+++++ | DC+++ | g₀ + (2 − A)g₁ | g₀ + 2g₁ − Ag₂ |
| −−++++− | DC++C | g₀ + (2 − A)g₁ − Ag₂ | g₀ + 2g₁ − Ag₂ |
| −−+++−− | DC+CD | g₀ + 2(1 − A)g₁ − 2g₂ | g₀ + 2g₁ − 2(1 + A)g₂ |
| ++++−−− | ++CD− | (1 − A)g₀ | g₀ − Ag₁ |
| −+++−−− | C+CD− | (1 − A)g₀ − Ag₂ | g₀ − Ag₁ |
| −−−++++ | −DC++ | (1 − A)g₀ | g₀ − Ag₁ |
| −−−+++− | −DC+C | (1 − A)g₀ − Ag₂ | g₀ − Ag₁ |
| +++−−−+ | +CD−D | −g₀−Ag₁ | −(1 + A)g₀ − Ag₂ |
| +++−−−− | +CD−− | −g₀ − Ag₁ | −(1 + A)g₀ |
| +−−−+++ | D−DC+ | −g₀ − Ag₁ | −(1 + A)g₀ − Ag₂ |
| −−−−+++ | −−DC+ | −g₀ − Ag₁ | −(1 + A)g₀ |
| ++−−−++ | CD−DC | −g₀ − 2g₁ + 2(1 − A)g₂ | −g₀ − 2(1 + A)g₁ + 2g₂ |
| ++−−−−+ | CD−−D | −g₀ − 2g₁ − Ag₂ | −g₀ − (2 + A)g₁ − Ag₂ |
| ++−−−−− | CD−−− | −g₀ − 2g₁ − Ag₂ | −g₀ − (2 + A)g₁ |
| +−−−−++ | D−−DC | −g₀ − 2g₁ − Ag₂ | −g₀ − (2 + A)g₁ − Ag₂ |
| −−−−−++ | −−−DC | −g₀ − 2g₁ − Ag₂ | −g₀ − (2 + A)g₁ |
| +−−−−−+ | D−−−D | −g₀ − 2g₁ − 2g₂ | −g₀ − 2g₁ − 2(1 + A)g₂ |
| +−−−−−− | D−−−− | −g₀ − 2g₁ − 2g₂ | −g₀ − 2g₁ − (2 + A)g₂ |
| −−−−−−+ | −−−−D | −g₀ − 2g₁ − 2g₂ | −g₀ − 2g₁ − (2 + A)g₂ |
| −−−−−−− | −−−−− | −g₀ − 2g₁ − 2g₂ | −g₀ − 2g₁ − 2g₂ |

In a favorable embodiment the apparatus is characterized in that the apparatus further comprises means able to derive an error signal by subtracting from the processed signal an estimate of the processed signal, the estimate being derived from an output signal of the bit detector by using the asymmetry parameter estimate, and the asymmetry parameter estimator means is able to produce an estimate of the asymmetry parameter at a sampling instant to by adding an error signal to a previous asymmetry parameter estimate if a bit detected by the bit detection means at a subsequent sampling instant t₀+1 has a same sign as a bit detected at a previous sampling instant t₀−1.

Central to the reliable operation of a receiver in the presence of asymmetry, as it is quantified by the non-linear model of (10), is the estimation of the asymmetry parameter A of the model. To this end we need a loop to control the estimate of A, which should ideally be independent of estimates of other parameters that the receiver keeps track of. Here we follow the approach proposed in [7]. We outline this approach in what follows. First we re-write (10) as:

$${b}_{k} = - \frac{A}{2} + {( a * h )}_{k} + \frac{A}{2} {s}_{k} \qquad ( 16 )$$

where

$${h}_{k} = ( 1 - \frac{\vert A \vert}{2} ) {δ}_{k} + \frac{\vert A \vert}{4} ( {δ}_{k - 1} + {δ}_{k + 1} )$$

is a linear impulse response, and sₖ is the second-order non-linear term

sₖ=aₖ(aₖ₊₁+aₖ₋₁)/2 (17)

taking values from {0,1}. According to (16), bₖ consists of a DC-offset

$$\frac{- A}{2} ,$$

a linear ISI component (a*h)ₖ, and a second order nonlinear component

$$\frac{A}{2} {s}_{k} .$$

Since DC offsets and linear ISI can arise in other parts of the system, the only component of bₖ that is un-ambiguously indicative of asymmetry is

$$\frac{A}{2} {s}_{k} .$$

This is the component that we need to detect in order to control parameter A.

We use the same error signal as in (12), where

$${\hat{b}}_{k} = {\hat{a}}_{k} - \frac{1}{4} ( \vert \hat{A} \vert + \hat{A} {\hat{a}}_{k} ) ( 2 {\hat{a}}_{k} - {\hat{a}}_{k + 1} - {\hat{a}}_{k - 1} ) \qquad ( 18 )$$

is an estimate of the transformed symbols bₖ computed from estimates Â of parameter A and âₖ of bits aₖ. Assuming that residual linear ISI and residual DC offsets are minimal and detection errors are absent, the error signal eₖ will contain a component proportional to (A−Â)(s*g)ₖ. Detection of this component is then achieved by cross-correlating eₖ with (s*g)ₖ, or, to simplify implementation, with sₖ. From (17), we see that sₖ is non-zero only away from transitions, that is when âₖ₋₁=âₖ₊₁. Update of parameter A is then performed through the iteration:

$${\hat{A}}^{K + 1} = \{ \begin{matrix}{\hat{A}}^{K} + μ {e}_{k} & if {\hat{a}}_{k - 1} = {\hat{a}}_{k + 1} \\ {\hat{A}}^{K} & otherwise\end{matrix} \qquad ( 19 )$$

where Âⁱ denotes the estimate of A at iteration i.

In an other embodiment the apparatus is characterized in that the bit detection means is a threshold detector with a slicer level, wherein the slicer level is a linear function of the asymmetry parameter estimate. This can for instance be done by deriving the slicer level by multiplying the asymmetry parameter estimate by a constant.

In traditional detection systems, the effect of asymmetry is compensated by an offset in the decision level of the threshold detector [8]. This offset is proportional to the amount of light reflected from the disc, and is varying during disc readout. The correct decision level is restored through a combination of feedback loops, which make use of the phase error from the PLL. Usually a slow loop is used for decision level acquisition during startup of readout, and a faster loop takes over after initial convergence. The tracking bandwidth of the faster loop can be increased, however, if a nominal value of the optimal slicer level in the presence of asymmetry is known. In that case, the fast loop can be designed to track only small variations around this optimal value, resulting in a smaller dynamic range. We will outline a procedure to calculate this optimal slicer level for a replay signal in asymmetry.

The optimal value of the TD slicer level lies in the middle of the inner eye-pattern of the signal at the detector input. In the presence of asymmetry, and for a 5-tap response gₖ, the noiseless detector input assumes 26 possible amplitude levels, listed in Table 2. The inner-eye levels are equal to (1−A)g₀−Ag₂ and −g₀−Ag₁ for A>0, and g₀−Ag₁ and −(1+A)g₀−Ag₂ for A<0, for land and pit, respectively. The optimal threshold level for the TD is then equal to

$$\frac{- A}{2} ( {g}_{0} + {g}_{1} + {g}_{2} ) ,$$

irrespective of the sign of A.

A further embodiment of the apparatus is characterized in that the bit detection means is a runlength pushback detector with a slicer level, wherein the slicer level is a linear function of the asymmetry parameter estimate. This can for instance be done by deriving the slicer level by multiplying the asymmetry parameter estimate by a constant.

In the presence of asymmetry it is necessary to also adjust the slicer level of the runlength pushback detector RPD for better performance. This slicer level is not necessarily equal to the slicer level of the standalone TD. A procedure to estimate this slicer level for the RPD has been proposed in [9], based on a different model for asymmetry than the one proposed here. The procedure however is general, and can also be applied to the present model. According to it, the optimal slicer level is estimated as the average between the data levels corresponding to any two transition bits. Referring to Table 2, the positive and negative data levels for two transition bits are given in the last four rows of the top part, and the first four rows of the second part of the table, respectively. Independent of the sign of A, it would necessitate 8 loops in order to estimate the optimal slicer level for the RPD. An alternative procedure that estimates the optimal RPD slicer level and only needs one control loop is presented in the following sub-section.

For the RPD, the optimal slicer level is determined by the amplitude levels corresponding to the edges of a pit and a land. In the presence of asymmetry these levels are different from the inner-eye levels (corresponding to edge bits in 3T domains), and, moreover, they are asymmetric. The data level corresponding to the edge-bit of a land equals

$$( 1 - A ) {g}_{0} - \frac{A}{3} {g}_{2} for A > 0 ,$$

and g₀−Ag₁ for A<0.

The corresponding data level in the edge of a pit equals −g₀−Ag₁ and

$$- ( 1 + A ) {g}_{0} - \frac{A}{3} {g}_{2} ,$$

for

A>0 and A<0, respectively. The optimal threshold level for the RPD is then equal to

$$- \frac{A}{2} ( {g}_{0} + {g}_{1} + \frac{{g}_{2}}{3} ) ,$$

independent of the sign of A.

We can make two observations at this point. First, the optimal slicer levels for both detectors are linearly proportional to asymmetry, through a simple relation to parameter A. This means that estimation and tracking of these levels during readout amounts to tracking of parameter A, through the algorithm of (19). Thus only one control loop is needed. The values of the optimal slicer levels derived here are also valid in the case of zero asymmetry, where they both vanish since A=0. Second, the two optimal levels are not equal, except for A=0. The higher the asymmetry, the more they deviate from each other.

A favorable embodiment of the apparatus characterized in that the bit detection means is a Viterbi detector which is able to use a partial response gₖ with L taps, the asymmetry parameter estimate and a sequence of L+2 subsequent bits to calculate amplitude levels for branch metric calculations for all combinations of the L+2 subsequent bits not including combinations that can not occur in the original digital information signal.

Focusing on maximum likelihood (ML) detection of replay signals in asymmetry, we identify two main approaches in the literature. In one of them [10], a non-linear model for asymmetry is devised in a first step, and an ML detector is designed around it. The method is reported to far outperform ML detectors designed around linear models of the replay signal (as the one described in section 3). However, the model for asymmetry proposed in [10] requires six parameters, on top of the partial response taps, in order to be fully specified. These parameters need to be iteratively estimated and this increases the complexity of the receiver.

In the second approach, reported in [11, 12], reference amplitude levels are used for the calculation of branch metrics in the VD. When the replay signal is linear these reference levels are the amplitude values at the partial response output, for all possible combinations of (L+1) bits at its input (as in (7)). For a d=2 sequence and L=4 there exist 12 such levels (8 of which are distinct), the ones shown in Table 1.

In the presence of asymmetry however, the writing process is non-linear, and the amplitude levels present in the replay signal are shifted (in a non-uniform way) with respect to their nominal (zero-asymmetry) positions. In [11] and [12] the new reference levels are estimated by tracking the occurrence of the respective sequences of (L+1) channel bits in the sliced replay signal, and averaging their corresponding amplitudes. To avoid errors due to the binary slicer, more advanced (intermediate) detectors can be used. Performance of both schemes is significantly superior to their VD counterpart that operates based on fixed levels derived from a linear partial response model. On the downside however, both schemes require the estimation, and recursive update, of a relatively large number of levels. This again causes a complexity increase with respect to the case of zero-asymmetry signals.

In the presence of asymmetry the replay signal is non-linear, and a VD designed around a linear model such as that of FIG. 1 can no longer be optimal 2. However, a VD that takes account of write non-linearities can be designed based on the model of FIG. 3. In that case, the sequence at the input of the VD is given by (13), or, equivalently, (14). The noiseless detector input then equals

zₖ=h(aₖ₋₃, . . . ,aₖ₊₂,aₖ₊₃)=g₀bₖ+g₁(bₖ₋₁+bₖ₊₁)+g₂(bₖ₋₂+bₖ₊₂) (20)

and is completely determined by a sequence of 7 consecutive channel bits. Accordingly, each state of the corresponding VD is a sequence of the 6 most recent bits in the channel memory, i.e.,

sₖⁱ≡{aₖ₋₃ⁱ, . . . ,aₖ₊₂ⁱ}, iε{0, . . . ,N_{d}} (21)

The underlying STD for a d=2 constraint is shown in FIG. 5. It consists of Nₛ=18 states and 26 branches in total.

Each branch uniquely defines a succession of 7 bits ak−3, . . . , ak+3, a noiseless detector input given by (20), and an associated branch metric as in (8). All the possible data levels zk (26 for each of A>0 and A<0, only 12 of which are distinct in each case) are shown in Table 2. Although the STD of FIG. 5 is considerably more complex than its counterpart in the zero-asymmetry case, only 8 out of the 18 states have more than one incoming branch, requiring 8 ACS operations per bit interval. However, this is still double than in the STD of FIG. 2.

The new VD produces decisions 4D for actual bits â_{k-D} in a similar fashion as the VD described in section 3. The only difference is in the computation of branch metrics and in the STD. We can re-formulate the VD in order to produce decisions b_{k-D} with respect to the transformed symbols bₖ instead. Estimates of the channel bits âₖ can then be produced from symbol-estimates bₖ through a memory-less inverse mapping. The states are now sequences of 4 consecutive symbols bₖ₋₂, . . . , bₖ₊₁, and the noiseless detector input is computed based on the second equality in (20). One might expect that the STD would be simplified due to the smaller number of symbols per state, however symbols bₖ assume values from a ternary alphabet. This again results in an 18-state, 26-branch STD, which is shown in FIG. 6. The values of variables C and D are given by (15), in accordance with Table 2. Estimates of aₖ are produced by mapping C to +1 and D to −1.

The STD of FIG. 6 is different from the one of FIG. 5 in one respect; it is easy to see that for one sign of asymmetry the STD of FIG. 6 can be simplified, since several states can be combined. For example, for A>0 (for which D=−1), states 5,6,7 and 12 all correspond to state {−−−}, states 4 and 13 correspond to {C—-}, while 8 and 14 correspond to {−−−C}. Similar simplifications can be made for A<0 (with C=+1). The simplified STDs are shown in FIGS. 7 and 8 for A>0 and A<0 respectively. Each has 13 states and 19 branches, and the respective VD performs 6 ACS operations per bit interval. The two STDs are completely symmetrical; in fact, the one for A<0 arises from the one for A>0 by changing the polarity of the bits comprising each state, and by replacing parameter C with D. Computation of the branch metrics is also symmetrical: corresponding branches (branches with opposite polarities) for A>0 and A<0, have equal-magnitude but opposite-sign associated data levels (zₖ). This is illustrated in Table 3, and translates into smaller memory requirements in order to store the values of the reference data levels in a look-up table. In fact, due to the symmetry of gₖ, only 12 out of the 19 data levels are distinct, and they completely specify the operation of the associated VD.

The complete symmetry between A>0 and A<0 suggests that we use the same (simplified) STD for both types of asymmetry. Since asymmetry tends to be relatively constant over one disc, no switch between polarities of detected bits is likely to be needed. A problem arises when asymmetry is small, or, equivalently, A≈0. In this case, the sign of A can easily fluctuate, and the VD must switch between polarities. However, this can be easily avoided by setting a ‘guard zone’ around A≈0. Whenever A falls within this ‘guard zone’, we automatically set A=0, and adopt one of the polarities for detected bits by default. Performance will not be affected, since, as we shall see, the VD designed around the linear channel model (A=0) is optimal for small values of |A|.

We should note that the simpler STD of FIG. 7 (or that of FIG. 8) retains the complete functionality of its 18-state counterpart of FIG. 5. The advantages of lower complexity and (anticipated) higher speed of implementation, are achieved without any sacrifice in performance. This is all made possible by the simplicity and complete symmetry (for positive and negative asymmetry) of the non-linear model of (10). However, the STD of FIG. 7 is still considerably more complex than the one of FIG. 2. In the following sub-section we propose further simplifications of the STD of the VD in the presence of asymmetry. It is shown that near-optimal performance can be achieved at almost no additional cost with respect to the VD for A=0.

In an other embodiment the apparatus is characterized in that the bit detection means is a Viterbi detector which is able to use a partial response gₖ with L taps, the asymmetry parameter, a sequence of L subsequent bits and at least two extra bits which are derived using at least one instantaneous bit detector, to calculate amplitude levels for branch metric calculations. The instantaneous bit-detector to be used for said at least two extra bits at the boundaries of said sequence of L subsequent bits, can for instance be comprised by the Viterbi detector and at least one of the two extra bits are derived with local sequence feedback during backtracking on a Viterbi trellis. Also the instantaneous bit-detector can be a threshold detector. Furthermore, the instantaneous bit-detector can be a runlength-pushback detector. We have seen that full exploitation of the non-linear model of (13) (or equivalently (14)) comes at the price of a significant increase in complexity, and an associated reduction of throughput, for the underlying VD. As we shall see however, the d=2 constraint on the channel bits and the structure of the non-linear model allow us to relax the associated ‘burden’.

TABLE 3
Admissible d = 2 5-bit sequences bₖ and corresponding noiseless
channel output, for a 5-tap symmetric channel.

| A > 0 | | A < 0 | |
|---|---|---|---|
| bₖ- | | bₖ- | |
| pattern | Sample value (zₖ) | pattern | Sample value (zₖ) |
| +++++ | g₀ + 2g₁ + 2g₂ | −−−−− | −(g₀ + 2g₁ + 2g₂) |
| ++++C | g₀ + 2g₁ + (2 − \|A\|)g₂ | −−−−D | −(g₀ + 2g₁ + (2 − \|A\|)g₂) |
| C++++ | g₀ + 2g₁ + (2 − \|A\|)g₂ | D−−−− | −(g₀ + 2g₁+ (2 − \|A\|)g₂) |
| C+++C | g₀ + 2g₁ + 2(1 − \|A\|)g₂ | D−−−D | −(g₀ + 2g₁ + 2(1 − \|A\|)g₂) |
| +++C− | g₀ + (2 − \|A\|)g₁ | −−−D+ | −(g₀ + (2 − \|A\|)g₁) |
| C++C− | g₀ + (2 − \|A\|)g₁ − Ag₂ | D−−D+ | −(g₀ + (2 − \|A\|)g₁ − Ag₂) |
| −C+++ | g₀ + (2 − \|A\|)g₁ | +D−−− | −(g₀ + (2 − \|A\|)g₁) |
| −C++C | g₀ + (2 − \|A\|)g₁ − Ag₂ | +D−−D | −(g₀ + (2 − \|A\|)g₁ − Ag₂) |
| −C+C− | g₀ + 2(1 − \|A\|)g₁ − 2g₂ | +D−D+ | −(g₀ + 2(1 − \|A\|)g₁ − 2g₂) |
| ++C−− | (1 − \|A\|)g₀ | −−D++ | −((1 − \|A\|)g₀) |
| C+C−− | (1 − \|A\|)g₀ − Ag₂ | D−D++ | −((1 − \|A\|)g₀ − Ag₂) |
| −−C++ | (1 − \|A\|)g₀ | ++D−− | −((1 − \|A\|)g₀) |
| −−C+C | (1 − \|A\|)g₀ − \|A\|g₂ | ++D−D | −((1 − \|A\|)g₀ − \|A\|g₂) |
| +C−−− | −(g₀ + \|A\|g₁) | −D+++ | g₀ + \|A\|g₁ |
| −−−C+ | −(g₀ + \|A\|g₁) | +++D− | g₀ + \|A\|g₁ |
| C−−−C | g₀ + 2g₁ − 2(1 − \|A\|)g₂) | D+++D | g₀ + 2g₁ − 2(1 − \|A\|)g₂) |
| C−−−− | −(g₀ + 2g₁ + \|A\|g₂) | D++++ | g₀ + 2g₁ + \|A\|g₂ |
| −−−−C | −(g₀ + 2g₁ + \|A\|g₂) | ++++D | g₀ + 2g₁ + \|A\|g₂ |
| −−−−− | −(g₀ + 2g₁ + 2g₂) | +++++ | g₀ + 2g₁ + 2g₂ |

In the following we concentrate on the STD of FIG. 5. In order to simplify this STD we form a reduced set of states consisting of 4 consecutive bits aₖ₋₂, . . . , aₖ₊₁. These states are the same as those of (6), and the STD that defines their succession (for a d=2 constraint) is the one of FIG. 2. Each branch of this STD defines a sequence of 5 bits aₖ₋₂, . . . , aₖ₊₂, which, according to (10), uniquely determines the 3-symbol sequence bₖ₋₁, bₖ, bₖ₊₁. Moreover, in many cases, bₖ₋₂ and/or bₖ₊₂ are also specified, irrespective of aₖ₋₃ and/or aₖ₊₃. This is a result of the d=2 constraint and the structure of the non-linear model. Consider, for example, the case of A>0. Then both bₖ₋₂ and bₖ₊₂ are uniquely determined for the branches labeled −+++−, ++−−−, and −−−++, +−−−+, −−−−−, −−−−+ and −−−−−. For the remaining branches however, knowledge of aₖ₋₃ and/or aₖ₊₃ is required. Similar arguments hold for A<0.

Let us re-write (10) as:

bₖ=aₖ+cₖ (22)

where cₖ is a deterministic non-linear function of aₖ₋₁, aₖ, aₖ₊₁, implied by (10). The noiseless detector input in the presence of asymmetry is given by (20). Using (22), we can re-write (20) as:

zₖ=g₀bₖ+g₁(bₖ₋₁+bₖ₊₁)+g₂(a_{k'2}+aₖ₊₂)+g₂(cₖ₋₂+cₖ₊₂)=\check{z}ₖ+g₂(cₖ₋₂+cₖ₊₂) (23)

Since zₖ depends on aₖ₋₃ (through cₖ₋₂) and aₖ₊₃ (through cₖ₊₂), it can not be fully specified (in general) by a branch in the STD of FIG. 2. Instead, k is fully determined from the reduced STD.

In order to fully exploit the model of (10) in branch metric calculations, we need to compute the ‘residual’ quantity g₂(cₖ₋₂+cₖ₊₂). Towards that end we need estimates of the digits aₖ₋₃ and aₖ₊₃, at least for some of the states in the STD. A reliable estimate of the ‘past’ bit aₖ₋₃ can be extracted from the surviving path associated with each state, in the form of a ‘local’ decision aₖ₋₃ (local sequence feedback), along the lines of [13]. As for the ‘future’ bit aₖ₊₃, it can be estimated from yₖ₊₃ by means of an instantaneous decision, for example âₖ₊₃=sgn(yₖ₊₃) (the same can also be applied for the ‘past’ bit aₖ₋₃). The variables cₖ₋₂ and cₖ₊₂ are accordingly estimated as:

$${\hat{c}}_{k - 2} = - \frac{1}{4} ( \vert A \vert + {Aa}_{k - 2} ) ( 2 {a}_{k - 2} - {a}_{k - 1} - {\hat{a}}_{k - 3} ) \\ {\hat{c}}_{k + 2} = - \frac{1}{4} ( \vert A \vert + {Aa}_{k + 2} ) ( 2 {a}_{k + 2} - {\hat{a}}_{k + 3} - {a}_{k + 1} ) \qquad ( 24 )$$

Note that cₖ takes values from {0,−A}, and is nonzero only in the immediate vicinity of transitions, and only for bits of one polarity (depending on the sign of A). As a result, the residual quantity g₂(cₖ₋₂+cₖ₊₂) is ternary, and takes values from

{0, −Ag₂, −2Ag₂} according to:

$${g}_{2} ( {c}_{k - 2} + {c}_{k + 2} ) = \{ \begin{matrix}\begin{matrix}\frac{1}{4} [ ( {\hat{a}}_{k - 3} - 1 ) ( {a}_{k - 2} + 1 ) + \\ ( {a}_{k + 2} + 1 ) ( {\hat{a}}_{k + 3} - 1 ) ] \cdot ( {Ag}_{2} ) , A > 0\end{matrix} \\ \begin{matrix}\frac{1}{4} [ ( {\hat{a}}_{k - 3} + 1 ) ( {a}_{k - 2} - 1 ) + \\ ( {a}_{k + 2} - 1 ) ( {\hat{a}}_{k + 3} + 1 ) ] \cdot ( {Ag}_{2} ) , A < 0\end{matrix}\end{matrix} \qquad ( 25 )$$

Note that no numerical computations are required in (25). To see this, (25) can be equivalently written as:

$${g}_{2} ( {c}_{k - 2} + {c}_{k + 2} ) = \{ \begin{matrix}\begin{matrix}- {Ag}_{2} , \\ \end{matrix} & \begin{matrix}if ( {\hat{a}}_{k - 3} = - 1 and {a}_{k - 2} = 1 ) \\ XOR ( {a}_{k + 2} = 1 and {\hat{a}}_{k + 3} = - 1 )\end{matrix} \\ \begin{matrix}- 2 {Ag}_{2} , \\ \end{matrix} & \begin{matrix}if ( {\hat{a}}_{k - 3} = - 1 and {a}_{k - 2} = 1 ) \\ AND ( {a}_{k + 2} = 1 and {\hat{a}}_{k + 3} = - 1 )\end{matrix} \\ 0 , & otherwise\end{matrix} \qquad ( 26 )$$

if (A>0), and

$${g}_{2} ( {c}_{k - 2} + {c}_{k + 2} ) = \{ \begin{matrix}\begin{matrix}- {Ag}_{2} , \\ \end{matrix} & \begin{matrix}if ( {\hat{a}}_{k - 3} = 1 and {a}_{k - 2} = - 1 ) \\ XOR ( {a}_{k + 2} = - 1 and {\hat{a}}_{k + 3} = 1 )\end{matrix} \\ \begin{matrix}- 2 {Ag}_{2} , \\ \end{matrix} & \begin{matrix}if ( {\hat{a}}_{k - 3} = 1 and {a}_{k - 2} = - 1 ) \\ AND ( {a}_{k + 2} = - 1 and {\hat{a}}_{k + 3} = 1 )\end{matrix} \\ 0 , & otherwise\end{matrix} \qquad ( 27 )$$

if (A<0).

As mentioned earlier, computation of the data level zₖ is completely determined by the succession of bits aₖ₋₂, . . . , aₖ₊₂ for a number of states. For the rest of the states, only \check{z}ₖ can be computed, and a residual term needs to be added to arrive at zₖ. For each branch in the STD of FIG. 2, Table 4 shows the associated succession of 5 bits aₖ₋₂, . . . , aₖ₊₂, all the possible ‘past’ and ‘future’ bits aₖ₋₃ and aₖ₊₃, the associated base level zₖ (or \check{z}ₖ if zₖ is not completely specified), and the residual term g₂(cₖ₋₂+cₖ₊₂) (wherever necessary), for both A>0 and A<0.

Through the use of Table 4, maximum likelihood detection for replay signals with asymmetry can be achieved based on the simple STD of FIG. 2. The added complexity with respect to the linear signal case amounts to a number of memory cells (entries of a look-up table) to store the additional levels, and some logic, to determine the sign of parameter A. However, the same number of ACS units as in the linear case is required.

TABLE 4
Branches of the STD for a 5-tap channel, corresponding 5-bit
sequences, possible ‘past’ and ‘future’ bits, and associated
base and residual data levels, for A > 0 and A < 0.

| branch | a_{k - 3} | aₖ-pattern | a_{k + 3} | base level (A > 0) | residual | base level (A < 0) | residual |
|---|---|---|---|---|---|---|---|
| 0 → 0 | + | +++++ | + | g₀ + 2g₁ + 2g₂ | 0 | g₀ + 2g₁ + 2g₂ | 0 |
| | + | | − | | −Ag₂ | | 0 |
| | − | | + | | −Ag₂ | | 0 |
| | − | | − | | −2Ag₂ | | 0 |
| 0 → 1 | + | ++++− | − | g₀ + (2 − A)g₁ | 0 | g₀ + 2g₁ − Ag₂ | 0 |
| | − | | | | −Ag₂ | | 0 |
| 7 → 0 | − | −++++ | + | g₀ + (2 − A)g₁ | 0 | g₀ + 2g₁ − Ag₂ | 0 |
| | | | − | | −Ag₂ | | 0 |
| 7 → 1 | − | −+++− | − | g₀ + 2(1 − A)g₁ − 2g₂ | 0 | g₀ + 2g₁ − 2(1 + A)g₂ | 0 |
| 1 → 2 | + | +++−− | − | (1 − A)g₀ | 0 | g₀ − Ag₁ | 0 |
| | − | | | | −Ag₂ | | 0 |
| 6 → 7 | − | −−+++ | + | (1 − A)g₀ | 0 | g₀ − Ag₁ | 0 |
| | | | − | | −Ag₂ | | 0 |
| 2 → 3 | + | ++−−− | + | −g₀ − Ag₁ | 0 | −(1 + A)g₀ | −Ag₂ |
| | | | − | | 0 | | 0 |
| 5 → 6 | + | −−−++ | + | −g₀ − Ag₁ | 0 | −(1 + A)g₀ | −Ag₂ |
| | − | | | | 0 | | 0 |
| 3 → 5 | + | +−−−+ | + | −g₀ − 2g₁ + 2(1 − A)g₂ | 0 | −g₀ − 2(1 + A)g₁ + 2g₂ | 0 |
| 3 → 4 | + | +−−−− | + | −g₀ − 2g₁ − Ag₂ | 0 | −g₀ − (2 + A)g₁ | −Ag₂ |
| | | | − | | 0 | | 0 |
| 4 → 5 | + | −−−−+ | + | −g₀ − 2g₁ − Ag₂ | 0 | −g₀ − (2 + A)g₁ | −Ag₂ |
| | − | | + | | 0 | | 0 |
| 4 → 4 | + | −−−−− | + | −g₀ − 2g₁ − 2g₂ | 0 | −g₀ − 2g₁ − 2g₂ | −2Ag₂ |
| | + | | − | | 0 | | −Ag₂ |
| | − | | + | | 0 | | −Ag₂ |
| | − | | − | | 0 | | 0 |

For reasons of completeness we mention several alternative ways for the computation of the reference levels. In a first method the 5-bit pattern corresponding to the current branch, possibly together with the digit-estimates âₖ₋₃ and/or, âₖ₊₃ (depending on the branch and the sign of A), and the sign of A, serve to access the associated amplitude level. Although the table has 26 entries for A>0 and an equal number for A<0, only 12 of these levels are distinct for each case. Moreover, the levels for A<0 are obtained from those for A>0 by a sign-reversal, as shown in Table 3. In total, 12 memory locations are required for storing the amplitude levels. The corresponding number for the zero-asymmetry case is 8 locations.

In a second method, the memory requirements are reduced at the expense of some extra computations. The 5-bit pattern associated with the current branch is used to select a base amplitude level (the fifth column for A>0 and the seventh for A<0 in Table 4). Subsequently, depending on âₖ₋₃ and/or âₖ₊₃ and on the current branch, a pre-computed residual term (sixth and eighth columns in Table 4 for A>0 and A<0, respectively) is added to the base level to calculate the final amplitude level. The residual term is required in only 7 out of the 26 levels, corresponding to 5 of the 12 possible branches. Only 8 memory cells are needed for storing the base levels, and 2 additional cells for the residual terms.

A third alternative is to compute a subset of the required amplitude levels. Since the outer levels in the noiseless eye-pattern, i.e. those that correspond to bit-patterns +++++ and −−−−−, are not critical for the performance of the VD, they can be suppressed to one ‘average’ level. This means using the level g₀+2g₁+(2−A)g₂ for the branch labeled 0−> (for A>0) and the level −g₀−2g₁−(2+A)g₂ for the branch 4−>4 (for A<0), irrespective of âₖ₋₃ and âₖ₊₃. The remaining levels are computed as in one of the previously-mentioned methods.

An embodiment of the apparatus is characterized in that the bit detection means is a Viterbi detector which is able to use a partial response gₖ with L taps, the asymmetry parameter and a sequence of L+2 subsequent bits to calculate amplitude levels for branch metric calculations for all possible combinations C₁ of L subsequent bits not including combinations that can not occur in the original digital information signal by averaging all possible combinations C₂ of a combination C₁ with two additional bits.

We have seen in the previous section that it is possible to incorporate the non-linear model for asymmetry in branch metric calculations, and at the same time use the STD of FIG. 2, through decision feedback. The added complexity amounts to a few extra memory locations and some logic. Here we eliminate this added complexity by trading some accuracy in branch metric computations.

We design a Viterbi detector around the STD of FIG. 2, and with the same number of data levels as for the VD in the absence of asymmetry. The data levels are calculated in such a way as to (partially) account for the non-linearity that is present in the replay signal in the case of nonzero asymmetry. Specifically, for each branch in the STD of FIG. 2 (each 5-bit sequence aₖ₋₂, . . . , aₖ₊₂ that is allowed by the code),

we define a data level ζ(aₖ₋₂, . . . , aₖ₊₂) as:

$$ζ ( {a}_{k - 2} , … , {a}_{k + 2} ) ≡ \frac{1}{\vert S \vert} {\sum }_{α , β ∈ S} h ( α , {a}_{k - 2} , … , {a}_{k + 2} , β ) \qquad ( 28 )$$

where h(.) is given in (20), α and β are binary-valued digits, and S contains all possible pairs of binary digits which result in a 7-bit sequence (α, aₖ₋₂, . . . , aₖ₊₂, β) that is allowed by the d=2 code. Finally, |S| denotes the cardinality of the set S. The computation of the new data levels is better illustrated by referring back to Table 4. For each entry in the first column of this table (each branch in the STD of FIG. 2), an associated data level is computed. This data level is the average of the data levels h(aₖ₋₃, . . . , aₖ₊₃) corresponding to all possible 7-bit sequences aₖ₋₃, . . . , aₖ₊₃ associated with the 5-bit sequence aₖ₋₂, . . . , aₖ₊₂ defined by the current branch. For example, for the branch labeled 0−>1 (which corresponds to the 5-bit sequence ++++−), and in the case that A>0, we need to average 2 data levels, namely g₀+(2−A)g₁ and g₀+(2−A)g₁−Ag₂. The resulting average data level is equal to

$${g}_{0} + ( 2 - A ) {g}_{1} - \frac{A}{2} {g}_{2} .$$

The same procedure is used to calculate all 12 average data levels (of which only 8 are distinct, as in the case of levels for A=0).

Note that the values of the average levels are completely determined by the partial response taps gₖ and the value of parameter A, through (28) and (20). Therefore, once A is determined they can be computed and tabulated. A VD using average data levels does not fully exploit the non-linear model of (10), since a smaller number of levels is used than what would actually be necessary. Moreover, the values of these levels are not fully accurate. Such a VD is therefore sub-optimal. We shall see however, that its performance is almost as good as its previously-described counterparts, although its complexity is identical to that of the VD for A=0.

A further embodiment of the apparatus is characterized in that the bit detection means is a Viterbi detector which is able to use a partial response gₖ with L taps, the asymmetry parameter, a sequence of L subsequent bits to calculate amplitude levels for branch metric calculations for all possible combinations of L subsequent bits not including combinations that can not occur in the original digital information signal by adding one value to the amplitude levels, the value being a constant multiplied by the asymmetry parameter.

Average data levels, described previously, can be alternatively calculated from ‘linear’ data levels (those corresponding to a linear underlying response and computed by (7)) by shifting each level accordingly. The level shifts are data-dependent and thus non-uniform. It is conceivable, however, that we can also generate appropriate data levels by shifting the ‘linear’ levels of (7) by a uniform amount, i.e. independent of the underlying bit-sequence of the corresponding branch, according to:

zₛ^{k}=g₀aₖ+g₁(aₖ₋₁+aₖ₊₁)+g₂(aₖ₋₂+aₖ₊₂)+C₀ (29)

where zₛ^{k} denotes the shifted data levels, and C₀ the amount of shift. These levels can then be used for branch metrics calculation in the VD, in the presence of asymmetry.

The constant level shift represents one degree of freedom in the data level calculation, which can be used to control the performance of the associated VD. Careful selection of the level shift can lead to significant performance gains, however the opposite is also true; detection performance is critically dependent on the choice of the shift. Analysis of dominant error events for different amounts of asymmetry

has shown that the optimal value for C₀ (denoted by Cₒₚₜ) is asymmetry-dependent according to:

Cₒₚₜ=−c.A (30)

Here c is a constant, whose value is completely determined (through a rather complicated formula) by the tap values gₖ. For gₖ=[0.29, 0.5, 0.58, 0.5, 0.29] we get c=0:52. This value of Cₒₚₜ has also been verified to work well in simulations. The added advantage is that Cₒₚₜ is linearly proportional to parameter A, which is in turn linearly related to disc asymmetry and thus easy to measure. In the next section we describe a method for adaptive estimation and tracking of parameter A. The same loop can then be used to track the value of Cₒₚₜ.

An embodiment of the apparatus is characterized in that the preprocessing means comprises:

a waveform equalizer able to equalize the read signal;

an asymmetry component estimator unit able to calculate an estimate of an asymmetry component in an output of the waveform equalizer using the asymmetry parameter, and

a subtracting unit able to subtract the estimate from the output of the waveform equalizer, resulting in the processed signal.

So far we have used the non-linear model of (10) in order to design new equalization and detection techniques (or modify existing ones) for optical disc replay signals in the presence of asymmetry. An alternative approach is to cancel the components of the replay signal that are due to asymmetry in order to reconstruct a linear, asymmetry-free version of the replay signal. This signal can then be treated in a conventional way, as described for example in sections 2 and 3. Cancellation of asymmetry can be achieved in an efficient way through exploitation of the simple structure of the model of (10).

Let us re-visit the model of (10), and use the simplification of (22) to re-write the non-linear symbols as bₖ=aₖ+cₖ, where

$${c}_{k} = - \frac{1}{4} ( \vert A \vert + {Aa}_{k} ) ( 2 {a}_{k} - {a}_{k + 1} - {a}_{k - 1} ) \qquad ( 31 )$$

totally captures the effect of asymmetry in bₖ. We can then write the equalizer output yₖ (see (13)) as:

yₖ=(b*g)k+uₖ=(a*g)ₖ+(c*g)ₖ+uₖ (32)

Using estimates of channel bits âₖ from a preliminary detector, and of the parameter A (obtained via the algorithm of (19)), we can get estimates of sequence cₖ, which we can use to form the sequence (ĉ*g)ₖ. Subtracting this sequence from yₖ we get (an estimate of) an asymmetry-free equalizer output xₖ as:

xₖ=yₖ(ĉ*g)ₖ=(\check{a}*g)ₖ+(c*g)ₖ+uₖ (33)

where \check{a}ₖ denotes estimates of the actual channel bits aₖ.

The sequence xₖ is linear on the channel bits aₖ, and conventional techniques can be used to derive estimates of bits aₖ. A general receiver topology for asymmetry cancellation and subsequent processing is illustrated in FIG. 9. In FIG. 9 the read signal rₖ is equalized by an equalizer 20. The output of the equalizer 20 is fed to a delay 21 and a threshold detector TD 22. The output of the TD 22 is fed to calculation means 23 which calculates the term

$${c}_{k} = - \frac{1}{4} ( \vert A \vert + A {a}_{k} ) ( 2 {a}_{k} - {a}_{k + 1} - {a}_{k - 1} ) ,$$

i.e. the right term of equation (10). The output of the calculation means is fed to convolution means 24 which determines the convolution between cₖ and the desired channel partial response gₖ. This convolution is subtracted from the delayed yₖ resulting in xₖ. xₖ is fed to a delay 27 and to a bit detector 25. The output of the bit detector 25 is fed to a second convolution means 26 which determines the convolution of aₖ and the desired partial response gₖ. This convolution product (â*g)_{k-Q} is subtracted from the delayed xₖ resulting in eₖ. Through an updated algorithm means 28 the taps wₖ of the equalizer 20 are updated. Note that partial response equalization is now based on the error signal of (2), and any of the detectors of section 3 can be used for the bit detector 25.

A final note is concerned with the performance of the asymmetry canceller. The bit-error-rate performance is ultimately determined by the quality of signal xₖ, which is in turn determined by the quality of the preliminary detector (a TD is used for that purpose in FIG. 9). Decision errors of that detector propagate in the calculation of ĉₖ and (ĉa*g)ₖ and cause erroneous cancellation, which manifests itself in the form of decision errors in the output of the final detector. This phenomenon is well-known ([15]) and cannot be avoided. Although more sophisticated preliminary detectors can be used, this usually comes at the expense of higher complexity, and, perhaps more importantly, more latency, which can be catastrophic for the stability of the control loops in the receiver.

In the following we compare the performance of various detectors for signals with varying degrees of asymmetry. In a first set of simulations we use the topology of FIG. 4 with several variants of the Viterbi detector in order to get bit estimates. In a second set, we compare the performance of the TD with and without cancellation of asymmetry, based on the topology of FIG. 9.

Simulated replay signals are generated according to the non-linear model of (9). The optical channel impulse response fₖ is generated according to the Braat-Hopkins model [16]. This means that the Fourier transform of fₖ is given by:

$$F ( Ω ) = \{ \begin{matrix}2 ( {cos}^{- 1} ( \frac{Ω}{{Ω}_{c}} ) - \frac{Ω}{{Ω}_{c}} \sqrt{1 - {( \frac{Ω}{{Ω}_{c}} )}^{2} , 0 \leq \vert Ω \vert \leq {Ω}_{c}} \\ 0 , {Ω}_{c} \leq \vert Ω \vert \leq 0.5\end{matrix} \qquad ( 34 )$$

where is a normalized measure of frequency (=1 corresponds to the baud-rate I/T), and Ω_{c} denotes the normalized cut-off frequency of the (lowpass) optical channel frequency response. For an optical recording system using a laser diode with wavelength λ and a lens with numerical aperture NA, the normalized (spatial) cut-off frequency is given by

$${Ω}_{c} = \frac{2 NA}{λ} T .$$

For the DVD system, with λ=650 nm, NA=0.6 and T=133 nm, we get Ω_{c}≈0:25. We use the DVD system as a carrier, and a sequence aₖ coded with the EFMPlus code [17] (a d=2, k=10 code used in DVD) as the input to the channel. The impulse response fₖ is calculated by taking the inverse FFT of F(Ω) and truncating the resulting response to 21 taps (10 taps around the maximum-amplitude tap). Varying amounts of asymmetry are considered by using different values of the parameter A in the model of (10). It can be shown ([2]) that, for the impulse response fₖdescribed above, and for DVD parameters, signal asymmetry (as defined in [6]) is related to the parameter A through:

Asymmetry≈0.16.A (35)

In the simulations A ranges from 0 to 1.5 in steps of 0.25, corresponding to asymmetry values of 0% up to 24%, in steps of 4%. The results for negative asymmetry are symmetrical and thus not shown here.

The asymmetric replay signal rₖ is passed to an equalizer with impulse response wₖ, which produces the sequence yₖ at its output (see (11)). The equalizer taps are adaptively adjusted based on the LMS algorithm, in order to minimize the mean square value of the error signal of (12). Equalizer adaptation aims at shaping the channel response fk to the target response gₖ=[0.29, 0.5, 0.58, 0.5, 0.29]. The Fourier transform of this response resembles the frequency response of the optical channel F(Ω) quite well, and is chosen for minimal noise enhancement. Estimates of parameter A are also computed iteratively, based on the update of (19).

The sequence yₖ at the output of the equalizer is applied to a detector in order to generate estimates of the channel bits aₖ. Six variants of the Viterbi detector are compared. The first is the one described in section 3, which follows the STD of FIG. 2, and uses (7) in order to calculate branch metrics. This VD is based on the assumption that its input sequence is linear, ignoring the non-linear effects of asymmetry. It is denoted here as ‘Linear’. The second VD also follows the STD of FIG. 2, but uses a look-up table (RAM) with adapted entries in order to calculate the branch metrics, according to [11], and is denoted as ‘RAM’. The third VD is the one of section 5.2, and follows the STD of FIG. 5. Branch metrics are computed based on (20), and the detector is denoted ‘Full-NL’. The fourth variant is the simplified VD (labeled ‘DF-NL’) of section 5.3.1, which uses the STD of FIG. 2 and computes branch metrics according to Table 4, with the aid of decision feedback. Next is the VD of section 5.3.2, which employs average data levels according to (28). It is also based on the STD of FIG. 2, and is labeled ‘AVG-NL’. Finally, the detector described in section 5.3.3 is considered. It is similar to the ‘Linear’ VD, but additionally employs a uniform baseline shift (whilst the name ‘Lin-UBS’) to the data levels of (7). The theoretically optimal value of (30) (with c=0.52) is used here.

For all detectors that incorporate the value of A in the calculation of data levels, the following procedure is followed: during a training session which comprises 30.000 replay signal samples, the value of A is adaptively estimated through (19). The loop is then stopped, and the steady-state value of A is used for all relevant detectors. In a more realistic scenario where asymmetry can vary during writing or mastering, the estimate of A has to be renewed, following the asymmetry variations: The look-up tables holding the estimated data levels also need to be renewed at the same frequency.

FIG. 10 illustrates the results of the comparison between the detectors. Shown is the SNR loss in dB for each detector (on the vertical axis), with respect to the Matched Filter Bound (MFB), over varying degrees of asymmetry (values of A, on the horizontal axis). The MFB corresponds to the performance of a single-symbol receiver in the absence of ISI, and is as such an upper limit for the performance of any other receiver. The SNR loss is computed at a bit-error-rate level equal to 10⁻⁴ for all the detectors considered. The channel SNR is defined in the MFB sense (in the absence of asymmetry) as

$$SNR = \frac{{E}_{b}}{{σ}_{u}^{2}} \qquad ( 36 )$$

where E_{b} is the energy of the response gₖ(E_{b}=1 here), and σᵤ² is the variance of the noise process uₖ. In the simulations, the noise variance is adjusted so as to arrive at a channel SNR ranging from 10 to 20 dB.

From FIG. 10 we can make a few observations. First of all, even the optimal detector for the non-linear model of (9) does not achieve the MFB performance for asymmetries higher than 8% (A>0.5). This implies that the single-bit error is not the dominant error event at high degrees of asymmetry, and any receiver will suffer a significant performance loss (at least equal to that of the ‘Full-NL’ detector) in this case.

Moreover, the ‘Linear’ VD of section 3 (with zero uniform baseline shift) is clearly inferior to all other detectors, implying that the non-linearities due to asymmetry can cause significant performance loss if not treated properly. The loss is proportional to the amount of asymmetry in the signal. How-ever, simply shifting the data levels of the ‘Linear’ VD by a (carefully selected) constant enhances the performance by 0.7-0.9 dB at high asymmetries (‘Lin-UBS’ curve).

All the other detectors perform similarly over the entire asymmetry range. However, both the ‘DF-NL’ and ‘AVG-NL’ detectors are by far simpler than the ‘Full-NL’, and their operational speeds can be significantly higher. The ‘RAM’ detector has an operational speed that is potentially comparable to that of the ‘DF-NL’ or ‘AVG-NL’, however it requires the adaptive tracking of many parameters (the reference amplitude levels), while ‘DF-NL’ and ‘AVG-NL’ only require tracking of parameter A of the non-linear model. This leads to simplified hardware, translating into savings in chip area and power dissipation. These savings are achieved at the expense of a small increase in memory requirements for the ‘DF-NL’ vs. the ‘RAM’ detector. However, the ‘AVG-NL’ detector alleviates even this small drawback.

In the second set of simulations we use the topology of FIG. 9 to cancel the asymmetry in the simulated replay signal. We compare the performance of the TD with and without asymmetry cancellation. The results are shown in FIG. 11, in terms of loss in SNR (vertical axis) relative to the binary slicer in the absence of asymmetry, for a fixed bit-error-rate of 10⁻⁵. The horizontal axis indicates varying degrees of asymmetry (values of A). The graph indicated with e shows the results before cancellation, the graph indicated with [symbol] shows the results after cancellation. We observe that cancellation of asymmetry leads to significant performance gains for moderate amounts of asymmetry, but which decrease above a certain degree of asymmetry. This is because, as asymmetry increases, errors of the preliminary detector propagate to the canceller, causing erroneous cancellation, which manifests itself in the bit-error-rate of the final detector. This phenomenon has been previously observed and analyzed in [15], for cancellation of non-linear ISI in the magnetic recording channel. So, for example, gains of about 1.0 dB arise for 8% asymmetry, rising to 3.0 dB for 16% asymmetry, and dropping to 2.5 dB for 24% asymmetry.

Contrary to the TD, it was observed that asymmetry cancellation does not improve the performance of the RPD. This is to be expected, however, since the RPD is significantly more robust to asymmetry than the TD. The same holds for the Viterbi detector, whose performance, after asymmetry cancellation, has been found to be similar to the performance of the ‘RAM’ detector described above.

These results indicate that asymmetry cancellation is only advantageous if detection is performed through a TD, and becomes less effective at very high degrees of asymmetry. If the final detector is not a TD, then it should probably be avoided, since it adds to the complexity of the receiver without bringing performance advantages in return.

Receivers for optical recording systems, especially Read-Only systems. Non-linearities in the mastering process in the form of under- or over-etching cause asymmetry in the replay signal. The proposed schemes are especially relevant for DVR-ROM in the case of DUV mastering. In that case, the (relatively) low resolution of the recording laser leads to narrow process windows, and small deviations of the laser power can give rise to high asymmetries. This is independent of the choice of the code, i.e., whether d=1 or d=2 is used. All of the proposed schemes are equally applicable to d=1 as well as d=2 codes, with according modifications of the underlying STDs.

### REFERENCES

[1] A. Farmer. (1995, June). Blue vs. Ultra Violet: the challenge of high density mastering. Nimbus Technology & Engineering, Ltd., UK. [Online]. Available: http://www.nimbus.ltd.uk/nte/101/buv.html.

[2] H. Pozidis, W. M. J. Coene and J. W. M. Berginans, “A simple nonlinear model for the optical recording channel,” in Proc. IEEE Int. Conf on Communications, June 2000, New Orleans, La., USA.

[3] J. W. M. Bergmans, “Partial Response Equalization”, Philips Journal of Research, vol. 42, no. 2, pp. 209-245, 1987.

[4] G. J. van den Enden, “Transmission System and Recording System Having a Simplified Symbol Detector”, European Patent, pat. no. EP0885499, issued Dec. 23, 1998.

[5] T. Nakagawa, H. Ino and Y. Shimpuku, “A Simple Detection Method for RLL Codes (Run detector)”, IEEE Trans. Magn., vol. 33, no. 5, pp. 3262-3264, September 1997.

[6] DVD Specifications for Read-Only Disc, version 1.0, August 1996.

[7] J. W. M. Bergmans, “Reference receiver for modulation codes”, internal Philips report, October 1999.

[8] E. F. Stikvoort and J. A. C. van Rens, “An All-Digital Bit Detector for Compact Disc Players”, IEEE J. Selected Areas in Communications, vol. 10, no. 1, pp. 191-200, January 1992.

[9] S. Gopalaswamy, N. S. Kee and B.Farhang-Boroujeny, “Decision-Directed Correction for Bloom in Optical Recording Channels”, Jpn. J. Appl. Phys., vol. 39, Part 1, no. 2B, pp. 834-836, February 2000.

[10] I. S. Hwang, Y. H. Lee, P. Y. Seong and J. Ko, “Partial response equalization with nonlinearity compensating signal asymmetry in DVD storage”, SPIE Proc. vol. 3401, pp. 96-102, 1998.

[11] W. M. J. Coene and R. J. van der Vleuten, “Generation of Amplitude Levels for a Partial Response Maximum-Likelihood (PRML) Bit Detector”, European Patent Application, PHN 17.088 EP-P, Sep. 18, 1998.

[12] M. Kagawa, J. Nakano, T. Abiko and S. Igarashi, “A study of asymmetry compensation for partial-response maximum-likelihood detection in optical recording media”, Jpn. J. Appl. Phys., vol. 37, part 1, no. 4B, pp. 2214-2216, April 1998.

[13] J. W. M. Bergmans, S. A. Rajput and F. A. M. van de Laar, “On the use of decision feedback for simplifying the Viterbi detector”, Philips Journal of Research, vol. 42, no. 4, pp. 399-428, 1987.

[14] J. W. M. Bergmans, W. M. J. Coene, R. Otte and S. Bramwell, “Transition Detector for CD and DVD”, European Patent Application, PHN 17.586 EP-P, Aug. 2, 1999.

[15] O. E. Agazzi and N. Seshadri, “On the Use of Tentative Decisions to Cancel Intersymbol Interference and Nonlinear Distortion (With Application to Magnetic Recording Channels)”, IEEE Trans. Information Theory, vol. 43, no.2, pp. 394-408, March 1997.

[16] G. Bouwhuis, J. Braat, A. Huijser, J. Pasman, G. van Rosmalen and K. Schouhamer Immink, Principles of Optical Disc Systems, Adam Hilger Ltd, Bristol, UK, 1985.

[17] K. A. S. Immink, “EFMPlus: the Coding Format of the Multimedia Compact Disc”, IEEE Trans. Consumer Electronics, vol. 41, pp. 491-497, 1995.

[18] In Seok Hwang et al, “Partial response equalization with nonlinearity-compensating signal asymmetry in DVD storage”, Optical Data Storage Conference (ODS) '98, ASPEN, CO, USA 10-13 MAY 1998, vol. 3401, pages 96-102.

1. Apparatus able to read information on a record carrier, which information is present on the record carrier in the form of marks, the apparatus comprising:
reading means able to read a data signal from the record carrier;
preprocessing means able to convert the read data signal into a processed signal suitable for further processing;
bit detection means able to derive an information signal from the processed signal;
channel decoding means able to decode the information signal, and
asymmetry parameter estimator means able to derive an asymmetry parameter estimate indicative of an asymmetry in the read signal,
characterized in that the asymmetry parameter estimate is substantially determined by deviations of the size of the marks with respect to a nominal size and the apparatus is able to improve a bit error rate of the information signal when the size of the marks deviate from the nominal size by using the asymmetry parameter estimate.

2. Apparatus as claimed in claim 1, characterized in that the bit detection means is a Viterbi detector which is able to use a partial response gₖ with L taps, the asymmetry parameter estimate and a sequence of L+2 subsequent bits to calculate amplitude levels for branch metric calculations for all combinations of the L+2 subsequent bits not including combinations that can not occur in the original digital information signal.

3. Apparatus as claimed in claim 1, characterized in that the bit detection means is a Viterbi detector which is able to use a partial response gₖ with L taps, the asymmetry parameter estimate, a sequence of L subsequent bits and at least two extra bits which are derived using at least one instantaneous bit detector, to calculate amplitude levels for branch metric calculations.

4. Apparatus as claimed in claim 3, where the Viterbi detector comprises the instantaneous bit-detector to be used for said at least two extra bits at the boundaries of said sequence of L subsequent bits, and at least one of the two extra bits are derived with local sequence feedback during backtracking on a Viterbi trellis.

5. Apparatus as claimed in claim 3, where the instantaneous bit-detector to be used for said at least two extra bits at the boundaries of said sequence of L subsequent bits, is a threshold detector.

6. Apparatus as claimed in claim 3, where the instantaneous bit-detector to be used for said at least two extra bits at the boundaries of said sequence of L subsequent bits, is a runlength-pushback detector.

7. Apparatus as claimed in claim 1, characterized in that the bit detection means is a Viterbi detector which is able to use a partial response gₖ with L taps, the asymmetry parameter estimate and a sequence of L+2 subsequent bits to calculate amplitude levels for branch metric calculations for all possible combinations C₁ of L subsequent bits not including combinations that can not occur in the original digital information signal by averaging all possible combinations C₂ of a combination C₁ with two additional bits.

8. Apparatus as claimed in claim 1, characterized in that the bit detection means is a Viterbi detector which is able to use a partial response gₖ with L taps, the asymmetry parameter estimate, a sequence of L subsequent bits to calculate amplitude levels for branch metric calculations for all possible combinations of L subsequent bits not including combinations that can not occur in the original digital information signal by adding one value to the amplitude levels, the value being a constant multiplied by the asymmetry parameter estimate.

9. Apparatus as claimed in claim 1, characterized in that the bit detection means is a threshold detector with a slicer level, wherein the slicer level is a linear function of the asymmetry parameter estimate.

10. Apparatus as claimed in claim 1, characterized in that the bit detection means is a runlength pushback detector with a slicer level, wherein the slicer level is a linear function of the asymmetry parameter estimate.

11. Apparatus as claimed in claim 1, characterized in that the preprocessing means comprises:
a waveform equalizer able to equalize the read signal;
an asymmetry component estimator unit able to calculate an estimate of an asymmetry component in an output of the waveform equalizer using the asymmetry parameter estimate, and
a subtracting unit able to subtract the estimate from the output of the waveform equalizer, resulting in the processed signal.

12. Apparatus as claimed in claim 1, characterized in that the apparatus further comprises means able to derive an error signal by subtracting from the processed signal an estimate of the processed signal, the estimate being derived from an output signal of the bit detector by using the asymmetry parameter estimate, and the asymmetry parameter estimator means is able to produce an estimate of the asymmetry parameter estimate at a sampling instant t₀ by adding an error signal to a previous asymmetry parameter estimate if a bit detected by the bit detection means at a subsequent sampling instant t₀+1 has a same sign as a bit detected at a previous sampling instant t₀−1.

13. Apparatus as claimed in claim 1, characterized in that the apparatus further comprises means able to derive an error signal by subtracting from the processed signal an estimate of the processed signal, the estimate being derived from a binary output signal of the bit detector by using the asymmetry parameter estimate, and the preprocessing unit comprises a waveform equalizer being a FIR filter with adjustable coefficients which are adjustable using an least mean square algorithm in order to minimize a mean square value of the error signal.

14. Method for reading information on a record carrier, which information is present on the record carrier in the form of marks, the method comprising the steps of:
reading a data signal from the record carrier;
converting the read data signal into a processed signal suitable for further processing;
derive an information signal from the processed signal;
decode the information signal, and
derive an asymmetry parameter estimate indicative of an asymmetry in the read signal,
characterized in that the asymmetry parameter estimate is substantially determined by deviations of the size of the marks with respect to a nominal size and the method uses the asymmetry parameter estimate to improve a bit error rate of the information signal when the size of the marks deviate from the nominal size.
